(19) United States
(12) Patent Application Publication
(10) Pub. No.: US 2007/0119258 A1
(43) Pub. Date: May 31, 2007

(54) Resonant vibratory device having high quality factor and methods of fabricating same

(75) Inventor: Karl Y. Yee, Pasadena, CA (US)

Correspondence Address: MARJAMA & BILINSKI LLP, 250 SOUTH CLINTON STREET, SUITE 300, SYRACUSE, NY, 13202, US

(73) Assignee: California Institute of Technology, Pasadena, CA (US)

(21) Appl. No.: 11/600,258

(22) Filed: Nov. 15, 2006

Related U.S. Application Data
(60) Provisional application No. 60/736,955, filed on Nov. 15, 2005.

(51) Int. Cl. G01H 17/00; G01P 15/097; G01P 9/04

(52) U.S. Cl. 73/649; 73/504.12; 73/514.29

(57) ABSTRACT

The invention provides resonant vibratory sensors to render such resonant vibratory sensors more beneficial than conventional MEMS-based and non-MEMS-based resonant vibratory sensors for various usage applications, such as portable applications requiring navigation-grade performance. The resonant vibratory sensors include as examples an oscillator, a vibratory gyroscope and a vibratory accelerometer. In one embodiment, the resonant vibratory sensor is a disk resonator gyroscope. The improved resonant vibratory sensors employ materials having an ultra low thermal expansion coefficient, which provides an improved thermoelastic quality factor.

### CROSS-REFERENCE TO RELATED APPLICATIONS

This application claims priority to and the benefit of co-pending U.S. provisional patent application Ser. No. 60/736,955, filed Nov. 15, 2005, which application is incorporated herein by reference in its entirety.

### STATEMENT REGARDING FEDERALLY FUNDED RESEARCH OR DEVELOPMENT

The invention described herein was made in the performance of work under a NASA contract number NASA-1407, and is subject to the provisions of Public Law 96-517 (35 U.S.C. §202) in which the Contractor has elected to retain title.

### FIELD OF THE INVENTION

The invention relates to vibratory devices in general and particularly to resonant vibratory devices having an improved quality factor compared to conventional devices.

### BACKGROUND OF THE INVENTION

Resonant devices, such as resonant vibratory devices and sensors, have long served various technical functions in many important industries. For example, in past decades resonant devices such as oscillators, vibratory sensors, gyroscopes and vibratory accelerometers, have been adapted in military and transportation applications.

In recent years, however, the demands of such industries have shifted or increased, and, in turn, characteristics and/or performance levels of resonant devices that were previously accepted as satisfactory have become unsuitable. For example, inertial technology in various industries had long relied upon inertial measurement units (IMUs) that employed fiber optic gyroscopes (FOGs) or ring laser gyroscopes (RLGs). Over time, it became clear that such devices tended to be disadvantageously large and power consumptive and/or suffered from issues relating to dead-band non-linearities and/or light source life. The large size/volume of such devices became a particular problem, since industries in which they were being used, especially the military and transportation industries, were increasingly seeking to incorporate such devices in miniature and/or portable platforms.

This led those in the art to begin developing MEMS-based resonant devices, such as MEMS-based gyroscopes. MEMS-based resonant devices offered several critical advantages (e.g., small volume and mass, low power usage, reduced cost through batch fabrication), which led to them being adopted on a widespread scale in various cutting edge technologies, such as in military sensors and weapons. Unfortunately, however, MEMS-based resonant devices were not without their shortcomings. Most notably, it was observed that some of such devices suffered from comparatively lower performance than non-MEMS-based counterparts. Consequently, some of the benefits gained from using MEMS-based resonant devices in lieu of predecessor devices were at least partially countered.

Thus, there is a need for resonant devices offering the benefits of MEMS-based resonant devices, and which also exhibit improved performance.

### SUMMARY OF THE INVENTION

In one aspect, the invention relates to a resonant vibratory sensor having an output signal proportional to a thermoelastic quality factor, Q_{TE}, wherein Q_{TE} is given by:

$${Q}_{TE} = {Q}_{o} [ \frac{1 + {( ω τ )}^{2}}{2 ( ω τ )} ]$$

$$where$$

$${Q}_{o} = \frac{2 {C}_{v}}{E {α}^{2} {T}_{o}}$$

Cᵥ=specific heat capacity
E=Young's modulus
α=coefficient of thermal expansion
Tₒ=nominal resonator temperature
τ=thermal relaxation time
ω=2π*(frequency of oscillation)

and wherein Qₒ is equal to at least 2,000,000.

In one embodiment, Qₒ is equal to at least 100,000,000. In one embodiment, the resonant vibratory sensor is formed at least in part from a material having a coefficient of thermal expansion, α, in the range given by −1.0×10⁻⁸≦α≦1.0×10⁻⁸. In one embodiment, the resonant vibratory sensor is formed at least in part from a material having a coefficient of thermal expansion, α, in the range given by −3.0×10⁻⁸≦α≦3.0×10⁻⁸. In one embodiment, the resonant vibratory sensor is formed at least in part from a glass. In one embodiment, the resonant vibratory sensor is fabricated using a glass molding process. In one embodiment, the resonant vibratory sensor is fabricated using a glass machining process. In one embodiment, the resonant vibratory sensor is formed at least in part from a silicate-based glass. In one embodiment, the resonant vibratory sensor is formed at least in part from a titania silicate based glass. In one embodiment, the resonant vibratory sensor is a gyroscope that has an in-run bias stability less than about 0.01 deg/hr. In one embodiment, the resonant vibratory sensor is a gyroscope that has an in-run bias stability less than about 0.001 deg/hr. In one embodiment, the resonant vibratory sensor is a gyroscope that has an angle random walk less than about 0.001 deg/hr^{1/2}. In one embodiment, the resonant vibratory sensor is a MEMS-based resonant vibratory sensor. In one embodiment, the resonant vibratory sensor has a volume of less than about 10 cm³. In one embodiment, the resonant vibratory sensor has a volume of about 1 cm³.

In one embodiment, the power required to operate the resonant vibratory sensor is less than about 0.5 watt. In one embodiment, the power required to operate the device is about 0.15 watt. In one embodiment, the resonant vibratory sensor is a device selected from the group consisting of an oscillator, a vibratory gyroscope and a vibratory accelerometer. In one embodiment, the resonant vibratory sensor is a disk resonator gyroscope. In one embodiment, the resonant vibratory sensor is fabricated in accordance with a dry etching process. In one embodiment, the dry etching process is a deep reactive ion etching process.

In another aspect, the invention features a resonant vibratory sensor formed at least in part from a glass material having a coefficient of thermal expansion, α, such that Qₒ is equal to at least 100,000,000 in accordance with the equation:

$${Q}_{TE} = {Q}_{o} [ \frac{1 + {( ω τ )}^{2}}{2 ( ω τ )} ]$$

$$where$$

$${Q}_{o} = \frac{2 {C}_{v}}{E {α}^{2} {T}_{o}}$$

Cᵥ=specific heat capacity
E=Young's modulus
α=coefficient of thermal expansion
Tₒ=nominal resonator temperature
τ=thermal relaxation time
ω=2π*(frequency of oscillation).

In a further aspect the invention relates to a resonant vibratory sensor formed at least in part from a glass material in accordance with a dry etching process, wherein the glass material has a coefficient of thermal expansion, α, such that Qₒ is equal to at least 2,000,000 in accordance with the equation:

$${Q}_{TE} = {Q}_{o} [ \frac{1 + {( ω τ )}^{2}}{2 ( ω τ )} ]$$

$$where$$

$${Q}_{o} = \frac{2 {C}_{v}}{E {α}^{2} {T}_{o}}$$

Cᵥ=specific heat capacity
E=Young's modulus
α=coefficient of thermal expansion
Tₒ=nominal resonator temperature
τ=thermal relaxation time
ω=2π*(frequency of

The foregoing and other objects, aspects, features, and advantages of the invention will become more apparent from the following description and from the claims.

### BRIEF DESCRIPTION OF THE DRAWINGS

The objects and features of the invention can be better understood with reference to the drawings described below, and the claims. The drawings are not necessarily to scale, emphasis instead generally being placed upon illustrating the principles of the invention. In the drawings, like numerals are used to indicate like parts throughout the various views.

FIGS. 1A-1C illustrate various views of an exemplary disk resonant gyroscope according to principles of the invention.

FIGS. 2A, 2B and 2C are plan views that illustrate successively enlarged sections of a portion of the disk resonant gyroscope of FIGS. 1A-1C.

FIGS. 3A and 3B are images that illustrate multi-axis embodiments of sensors comprising a plurality of MEMS-based resonant vibratory sensors.

FIGS. 4A-4D illustrate the fabrication process for a ULE DRG.

FIG. 5A is an illustration of a wafer comprising a plurality of prior art silicon DRG devices.

FIG. 5B is an illustration showing an IR microscopy image of a silicon DRG that shows the die underneath the silicon cap.

FIG. 6 is a diagram showing a cross sectional view of a vacuum package with a DRG die situated therein.

FIG. 7 is a diagram illustrating a concept for a DRG with an ASIC in a LCC package.

FIG. 8 is a diagram showing a leaderless chip carrier (LCC) package.

FIG. 9 is a diagram that illustrates an ASCI Breadboard Field Programmable Gate Array (FPGA) based digital electronics module that has been designed for the DRG.

As used herein, the following acronyms are to be understood as expressed immediately hereinbelow unless otherwise defined herein:

ASIC Application Specific Integrated Circuit

CCD Charge Coupled Device

COTS Commercial Off-the-Shelf

CTE Coefficient of Thermal Expansion

CVD Chemical Vapor Deposition

DRG Disc Resonator Gyro

DRIE Deep Reactive Ion Etch

DSP Digital Signal Processing

EOIR Electro-Optical Infrared

FOG Fiber Optic Gyroscope

FPGA Field Programmable Gate Array

HRG Hemispherical Resonator Gyroscope

IC Integrated Circuit

ICP Inductively-Coupled Plasma

IMU Inertial Measurement Unit

LCC Leadless Chip Carrier

MEMS Micro Electro-Mechanical System

MOEMS Micro Opto-Electro-Mechanical Systems

Ni Nickel

PECVD Plasma Enhanced Chemical Vapor Deposition

Q Mechanical Quality Factor

RIE Reactive Ion Etching

RLG Ring Laser Gyroscope

Si Silicon

ULE Ultra Low Expansion

### DETAILED DESCRIPTION OF THE INVENTION

The present application discloses resonant vibratory sensors, which, by virtue of being formed from material exhibiting an ultra low coefficient of expansion (e.g., titania silicate glass) are believed to provide an unprecedented combination of small size/volume, low power consumption, high precision and high performance. The approach is expected to provide an improvement in performance (i.e. bias stability and ARW) that is expected to be of the order of one thousand-fold improvement over existing commercial MEMS devices. Reduction of mass, volume and power over comparable performance optical gyros is projected to be of the order of a factor of one hundred (100). Based on modeled data, it is further believed that resonant vibratory sensors made from such a material would be better suited than conventional MEMS-based resonant vibratory sensors for many important uses, including as portable, navigation-grade, inertial measurement units (IMUs) for applications that include targeting, alignment, stabilization, navigation and/or guidance. The term “resonant vibratory sensor” refers to devices and equipment (e.g., oscillators, gyroscopes, accelerometers, chip-scale clocks, RF filters and chemical sensors) that are usable as IMUs and in various other applications. By way of non-limiting example, a resonant vibratory gyroscope can be a disc resonator gyroscope (DRG) or a hemispherical resonator gyroscope (HRG). The term “MEMS-based” refers to a device that has a volume in the range of cubic micrometers to cubic centimeters, including all subranges there between.

It is also recognized that another potential approach to achieve miniaturization, power reduction, and cost reduction in optical gyros can be attempted using MOEMS (Micro Opto-Electro-Mechanical Systems) technology. However, the MOEMS approach has proven difficult to date, for the reason that the output signal amplitude of an optical gyro is proportional to the total optical path length times the diameter of the circulation path. This makes it hard to achieve small devices with reasonable performance.

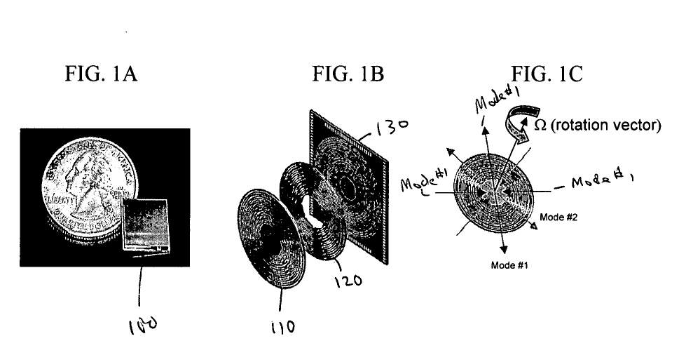

FIGS. 1A-1C depict several views of an exemplary resonant vibratory sensor 100, which, as shown, is a DRG 100.

FIG. 1A is an illustration showing a single axis Disc Resonator Gyroscope (DRG), with a United States quarter dollar coin as a size reference. The Disc Resonator Gyroscope 100 shown measures 11.4×11.4×1.3 mm, or 0.16 cubic centimeter in volume. The in-run bias stability has been measured at 0.25 deg/hr.

FIG. 1B is an illustration showing an exploded view of a DRG. Multiple narrow periodic slot segments etched through a planar wafer disc 110 (the front-most structure in FIG. 1B) simultaneously define a unique in-plane resonator structure and a matching large area electrode array 120 (the middle structure in FIG. 1B) for capacitive sense and actuation having very high area efficiency. The base or support plate 130 includes contacts for making electrical connection to drive the electrodes and to sense signals.

FIG. 1C is an illustration showing the degenerate oscillation modes (Mode #1 and Mode #2) of the resonator ring structure, in which the arrows indicate instantaneous direction of motion of mass elements of the ring structure. Each mode includes an expansive component and a compressive component, oriented at an angle of 90 degrees to each other. For example, for Mode #1 as depicted, the expansive component is oriented along what would be considered the Y axis of the disc (e.g., the arrows pointing away from the center of the disc) and the compressive component is oriented along what would be considered the X axis of the disc (e.g., the arrows pointing toward the center of the disc). The corresponding components of Mode #2 are rotated relative to the components of Mode #1 by 45 degrees as shown.

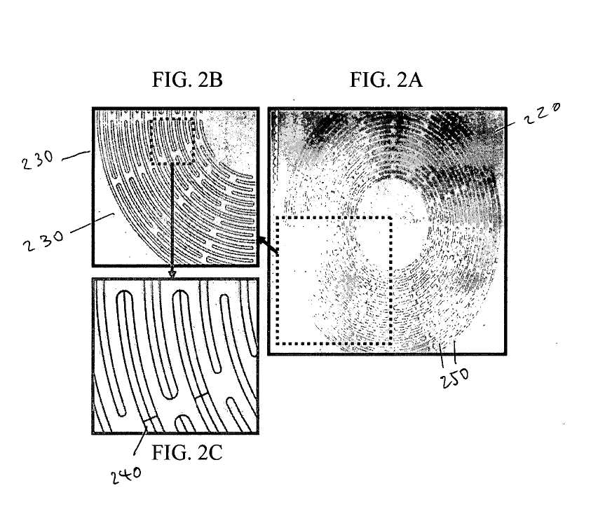

FIGS. 2A, 2B and 2C are plan views that illustrate successively enlarged sections of a portion of the disk resonant gyroscope of FIGS. 1A-1C. The exemplary DRG 100 includes a plurality of trenches 250, which individually and collectively define the structure and the electrodes of the DRG. Multiple narrow periodic slot segments 210 are etched through a planar wave disc 220 and simultaneously define an in-plane resonator structure 230 of the DRG and a matching large area electrode array 240. This will be further explained hereinafter with respect to the discussion of the fabrication of the devices.

The DRG 100 generally has two modes of operation. A sinusoidal voltage applied to one set of its electrodes drives its ring structure into a quadrupole first oscillation mode, for example Mode #1 in FIG. 1C. This motion couples to the Coriolis force, thus exciting the second, degenerate, quadrupole mode of its ring structure (e.g., Mode #2 of FIG. 1C). A feedback voltage signal applied to a second set of electrodes (rotated from the first set of electrodes by 45°) suppresses the motion of the second mode.

These dual modes of operation provide certain advantages and benefits. A direct proportionality exists between the Coriolis rate input and the feedback voltage. Therefore, the rotation rate of the DRG 100 can be extracted from a measurement of the feedback voltage. This allows for a high degree of designed-in symmetry of the DRG 100, which, in turn, ensures minimal coupling to external disturbances. The centrally mounted DRG 100 resonator supports two degenerate elastic inertial waves for Coriolis sensing having zero momentum relative to the baseplate, thus enabling all modal momentum of the DRG to remain locked within the resonating medium. This feature, which eliminates noisy and non-repeatable anchor losses, and, with appropriate geometric design of the DRG 100 resonator, results in a very high and very stable mechanical quality limited only by material damping. This very high quality, precision photolithographically-defined symmetry leads to low gyro bias, which is highly repeatable and predictable over temperature extremes. The co-etched resonator/electrode structure of the DRG 100 efficiently maximizes use of the area of the DRG to increase sensing capacitance, thus increasing the signal to noise ratio. Further, the axially symmetric design of the DRG 100 and its nodal support ensure minimal coupling to package stresses. The DRG is predicted, via load analysis, to survive acceleration loads in excess of one thousand times the acceleration of gravity (e.g., over 1000 g).

These various benefits and advantages of the geometrical design of a DRG have been achieved by conventional MEMS-based resonant vibratory sensors. However, as noted above, MEMS-based resonant vibratory sensors, including gyroscopes such as DRGs, have not performed up to the standards required for certain important applications. In particular, the performance of conventional MEMS-based resonant vibratory sensors (e.g., gyroscopes such as DRGs) has been observed to be, or has been determined via modeling to be inadequate for portable applications requiring navigation-grade performance.

It is believed based on theoretical considerations that the performance of a MEMS-based resonant vibratory sensor can be increased by observing that the output signal of any resonant vibratory sensor is proportional to 2πQ/ [symbol] , also referred to as the ring down time for the resonant vibratory sensor. Q represents the so-called “quality factor” for the resonant vibratory sensor, whereas ω is equal to the resonant (angular) frequency of the sense mode of the sensor. The thermoelastic quality factor, Q_{TE}, is calculated in accordance with the equation:

$${Q}_{TE} = {Q}_{o} [ \frac{1 + {( ω τ )}^{2}}{2 ( ω τ )} ]$$

$$where$$

$${Q}_{o} = \frac{2 {C}_{v}}{E {α}^{2} {T}_{o}}$$

Cᵥ=specific heat capacity
E=Young's modulus
α=coefficient of thermal expansion
Tₒ=nominal resonator temperature
τ=thermal relaxation time
ω=2π*(frequency of oscillation).

Scrutiny of this equation reveals that the quality factor is strongly dependent on the absolute temperature and various intrinsic material properties for the given design of a resonant vibratory sensor. Therefore, it follows that increasing the quality factor through a change in the material from which the resonant vibratory sensor is formed will boost the sensitivity of the resonant vibratory sensor by increasing the amplitude of its output signal. Moreover, as noted in the literature (see, e.g., T. V. Roszhart, “The effect of thermoelastic internal friction on the Q of micromachined silicon resonators”, IEEE Solid State Sensor and Actuator Workshop, Hilton Head, S.C., 6 4-7, 489, 1990), for a given resonant vibratory sensor the maximum heat flow due to acoustic mode coupling to the strain field (i.e., the minimum thermoelastic quality factor, Q_{TE}) arises when the thermal relaxation time constant for the resonant vibratory sensor is equal to the reciprocal of the vibration frequency. Additionally, for a given resonant vibratory sensor, it has been further observed that Q_{TE} for the resonant vibratory sensor can be increased by minimizing anchor losses, losses due to bulk material defects, and surface effects.

Despite these observations, it is also understood that the value of Q_{TE} can be increased only to a certain degree for a given resonant vibratory sensor. In other words, a theoretical maximum Q_{TE} value exists for a resonant vibratory sensor due to heat flow driven by local temperature gradients within the resonant vibratory sensor that result from the strain field within the medium. This theoretical maximum Q_{TE} for a given resonant vibratory sensor is determined primarily by geometric factors and the properties of the material from which the resonant vibratory sensor is fabricated.

For a given resonator, Q can be increased by minimizing anchor losses, losses due to bulk material defects and surface effects. However, a theoretical maximum Q value would still exist due to heat flow driven by local temperature gradients within the resonator resulting from the strain field within the medium. This theoretical maximum quality factor for a given resonator is determined primarily by geometric factors and the properties of the material that the resonator is fabricated from. This theory of thermoelastic damping effects is certainly not new. Originally developed by Zener (Phys. Rev. 52, 230, 1937), it has been refined by Lifshitz and Roukes (Physical Review B, 61, 5600, 2000) and Houston et. al (Appl. Phys. Ltrs, 80, 1300, 2002). Thermoelastic damping has been verified empirically as a major energy loss mechanism in MEMS structures by Duwel et. al (Sensors and Actuators A, 103, 70, 2003). These theoretical and empirical results lead one to the conclusion that materials with low thermal expansion coefficients are needed for producing the highest Q micromechanical resonators.

For a given material, the highest thermoelastic limit for Q_{TE} is attained by designing the resonator such that the reciprocal of the thermal relaxation time of flexures within the resonator is far away from the resonant frequency of the resonator. With these criterion, one is able to identify fused silica (i.e. amorphous quartz) as being a superior resonator material to silicon, and the optimal scale to build such a device as meso-scale (i.e. ˜1 cm in size). Fused silica, with a thermal expansion coefficient of only 5.5×10⁻⁷ per ° C., has long been known to be a very good material for high quality resonator construction. For example, the sense element of Litton's Hemispherical Resonator Gyroscope (HRG) is a macroscopic, wineglass-shaped, fused silica resonator with a measured Q factor of ˜5×10⁶. Recently, DRIE oxide etching systems have become available that should enable the fabrication of MEMS devices made of amorphous quartz.

The value of Q_{TE} is proportional to Qₒ, the value of which is calculated by determining the mathematical relationship between various materials properties, including the coefficient of thermal expansion, α. Qₒ is inversely proportional to the square of α.

The factor Qₒ is dependent upon the absolute temperature, Tₒ, and upon intrinsic material properties of the resonator, such as specific heat capacity, Cᵥ, and the coefficient of thermal expansion, α The factors τ and ω in the factor [1+(ωτ)²]/2(ωτ) are geometry dependent. For a given resonator, the maximum heat flow due to acoustic mode coupling to the strain field (i.e. minimum thermoelastic quality factor, Q_{TE}) arises when the thermal relaxation time constant, τ, for the resonator is equal to the reciprocal of the vibration frequency, ω (T. V. Roszhart, “The effect of thermoelastic internal friction on the Q of micromachined silicon resonators”, IEEE Solid State Sensor and Actuator Workshop, Hilton Head, S.C., 6 4-7, 489, 1990).

Therefore, it expected that, all other things being equal, the smaller the value for α, the larger the value of Qₒ and the larger the value of Q_{TE} as well. Accordingly, it is expected that forming resonant vibratory sensors from materials with low thermal expansion coefficients will influence whether the resonant vibratory sensors have a high thermoelastic quality factor.

As shown in TABLE 1 below, modeling and measurements performed in furtherance of the present application has provided estimates of the quality factor for resonant vibratory sensors that are formed from various materials having low (i.e., 1.0×10⁻⁶ or less) coefficients of thermal expansion, α. A comparison of these various values and measurements at room temperature are shown in TABLE 1, and are compared with the modeled data for a ULE® glass.

TABLE 1

| | Crystalline | | Crystalline | Fused | ULE ® titania |
|---|---|---|---|---|---|
| | Quartz | Silicon | Diamond | Silica | silicate glass |
| α (1/deg C.) | 8.1 × 10⁻⁶ | 2.5 × 10⁻⁶ | 1.2 × 10⁻⁶ | 5.5 × 10⁻⁷ | 0 ± 3.0 × 10⁻⁸ |
| Q₀ | 795 | 10,000 | 16,500 | 855,000 | 186,000,000 |

As shown from Table 1, a resonant vibratory sensor that is made from any of these materials would have a high Qₒ; however, the modeled Qₒ value for a resonant vibratory sensor made from fused silica (i.e., amorphous quartz) is more than 50 times greater than that of a resonant vibratory sensor made from any of the other materials. Therefore, because Qₒ, is proportional to Q_{TE}, one would likewise expect the Q_{TE} value for a resonant vibratory sensor made from fused silica to be much higher than the Q_{TE} for a resonant vibratory sensor made from one of these other materials. It is also noteworthy that the value of Qₒ increases as a decreases.

At present, at least some resonant vibratory sensors are made of fused silica, such as the Hemispherical Resonator Gyroscope (HRG), which is a macroscopic, wineglass-shaped, fused silica resonant vibratory sensor that is commercially available from Litton Industries, Inc. Various characteristics of prior art gyroscopes were comparatively assessed, as shown below in TABLE 2, and are compared with the modeled data for a resonant vibratory gyroscope formed from ULE® glass.

TABLE 2

| | | | | DRG formed |
|---|---|---|---|---|
| | | | HRG formed | from ULE ® |
| | GG1320 | FOG | from fused | titania |
| | (RLG) | 1000 | silica | silicate |
| | (Honeywell) | (Litton) | (Litton) | glass |
| Bias stability (°/hr) | 0.004 | 0.01 | 0.01 | <0.005 |
| ARW.(°/hr^{1/2}) | 0.004 | 0.004 | 0.0006 | <0.001 |
| Power (watts) | 2 | 2 | 4 | 0.15 |
| Volume (cm³) | 60 | 40 | 50 | 1 |

TABLE 2 compares various data for the GG1320 ring laser gyroscope (RLG) that is commercially available from Honeywell and the FOG 1000 fiber optic gyroscope that is commercially available from Litton Industries Inc., and the Litton fused silica HRG. As can be observed from the data presented in TABLE 2, the Litton HRG made from fused silica provides a superior (e.g., smaller) angle random walk (ARW) as compared to the other MEMS-based gyroscopes and a bias stability that is superior to that of the Honeywell GG 1320 RLG and equal to that of the Litton FOG 1000. However, the volume of the Litton HRG is greater than that of the Honeywell GG 1320 RLG and is only somewhat less than the volume of the Litton FOG 1000. A cube having an edge of approximately 1.45 inches (3.68 cm) is a volume of approximately 50 cm³. Moreover, the Litton HRG consumes twice as much power as either the Honeywell GG 1320 RLG or the Litton FOG 1000.

Thus, despite the benefit of the very high modeled quality factor measurement for the Litton HRG made of fused silica, its volume and angle random walk factors are such that the Litton HRG might not be optimally suited for certain resonant vibratory sensor applications in which such factors are important. For example, the high volume of the Litton HRG would prevent it from being suited for some portable applications.

Based on the data in TABLES 1 and 2 for prior art devices, it would appear that it is not possible to form a MEMS-based resonant vibratory sensor from a material that provides excellent performance (as indicated by a high quality factor) yet that also exhibits bias stability, angle random walk, power consumption and volume measurements that are lower than those of conventional resonant vibratory sensors. It was discovered that resonant vibratory sensors formed from certain glass materials can provide each of these various benefits. In particular, it was discovered that resonant vibratory sensors made from certain silicate glass materials, such as titania silicate glass materials (e.g., ULE® glass that is commercially available from Corning Inc., One Riverfront Plaza, Corning, N.Y. 14831), provide a modeled quality factor value that is higher than that of a resonant vibratory sensor made of fused silica, while also having lower modeled bias stability, angle random walk, power consumption and volume measurement than each of the state-of-the-art Litton HRG, the Litton FOG 1000 and the Honeywell GG1320 RLG resonant vibratory sensors.

As shown by the data in TABLES 1 and 2, a resonant vibratory sensor formed from a titania silicate glass such as ULE® glass provides a modeled quality factor that is 200 times that of fused silica, which itself was more than 50 times higher than any of the other listed materials. Thus, it is expected that a resonant vibratory sensor formed from a titania silicate glass such as ULE® glass would perform better than one made of one of these other materials, including even one made of fused silica. Moreover, unlike what was observed with respect to resonant vibratory devices that are made of fused silica (e.g., the Litton HRG), it is evident from the modeled data presented in TABLE 2 that this very high quality factor value does not come at the expense of any other important barometers of the performance and end use applicability, namely bias stability, angle random walk, power consumption and volume. Rather, the values for these parameters are lower for a resonant vibratory sensor made of a titania silicate glass such as ULE® glass than for each of the Litton HRG, the GG1320 RLG made by Honeywell and the FOG 1000 made by Litton. In particular, the volume and power consumption values for a resonant vibratory sensor made of a titania silicate glass such as ULE® glass are at least a factor of ten lower than the values for resonant vibratory sensors made of a conventional material.

It is theorized that a resonant vibratory sensor (e.g., a disk resonator gyroscope (DRG)) that is made of a titania silicate glass such as ULE® glass will perform well enough to be suitable for all MEMS-based resonant vibratory sensor applications, including those requiring navigation grade capabilities, yet also will have low bias stability, angle random walk, power consumption and volume, thus rendering such sensors even more beneficial than conventional MEMS-based and non-MEMS-based resonant vibratory sensors made of other materials.

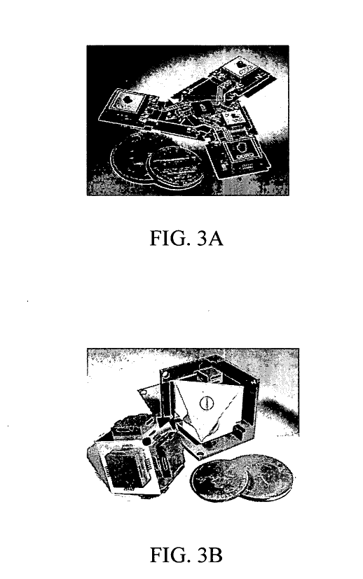

FIGS. 3A and 3B are images that illustrate multi-axis embodiments of sensors comprising a plurality of MEMS-based resonant vibratory sensors. FIG. 3A illustrates a design using a flex mounted triad of gyros, 3 axis accelerometer and central DSP. FIG. 3A illustrates a design using a DRG based 3-axis IMU. The volume of the assembly in FIG. 3B is less than 1 cubic inch. United States one cent and quarter dollar coins are shown in each drawing to provide a sense of the dimensions of each multi-axis sensor.

A ULE glass DRG, coupled with a low power ASIC, is expected to yield comparable performance to state of the art optical gyros with approximately two orders of magnitude reduction in volume and in power consumption.

Some of the features and benefits of the DRG design include the following:

The design provides high sensitivity through high Q, which is useful to improve the rate bias and the angle random walk. Improved rate bias reduces bias by improved drive-to-sense coupling and therefore improves bias drift as a function of temperature variations. Improved ARW improves the signal to noise ratio (SNR). This is accomplished by minimizing the anchor loss through mounting at a node (i.e., central mount), minimizing thermoelastic damping through design and material selection (including the use of ULE glass), and minimizing the thickness of conductive layers with novel processing, including depositing very thin metallization.

Stability over temperature variations provides the benefits of bias stability and low bias drift. In some embodiments the changes in resonator properties are preferably small and predictable to enable compensation as a function of temperature. This is accomplished by use of low CTE material (for example. ULE glass) that provides dimensional stability over temperature; minimization of non-intrinsic damping and thermoelastic damping; employing a homogeneous ULE glass resonator and package; providing a symmetric construction in both the resonator and the package; and providing low residual stress at the mounts and on the resonator.

Tuned operation provides the benefits of large signals and increased SNR, which prevents electronic noise from degrading performance. This is accomplished by using an axially symmetric disk resonator design; maintaining precise control over all resonator dimensions including stem placement through lithography and MEMS-type processing; the use of a homogeneous resonator material (for example ULE glass); and providing electrostatic tuning.

A large sensing area provides the benefits of large signals and increased SNR, which prevents electronic noise from degrading performance. This is accomplished by using an embedded electrode design that permits a highly efficient use of device area and therefore allows the device to have a small overall size.

A cost effective and manufacturable design provides the benefits of permitting widespread use, including in expendable products, such as defense products. This is accomplished by using a design that permits the application of standard and common MEMS fabrication processes in manufacture.

Various techniques can be utilized for fabricating a resonant vibratory sensor (e.g., a DRG as shown in FIGS. 2A-2C and 3A-3B) from a titania silicate glass such as ULE® glass.

Based on published data for etching of quartz, it is believed that aluminum, chrome and nickel are good mask materials for ULE glass etching. Quartz etch recipes are believed to be useful for etching ULE. Atomic Layer Deposition (ALD) and Plasma Enhanced Chemical Vapor Deposition (PECVD) silicon are believed to be useful for deposition of the conductive layer. After devices are fabricated, they should be tested. It is expected that suitable characterizations will include characterization as resonators, as gyroscopes, and as the resonators for vacuum packaged devices.

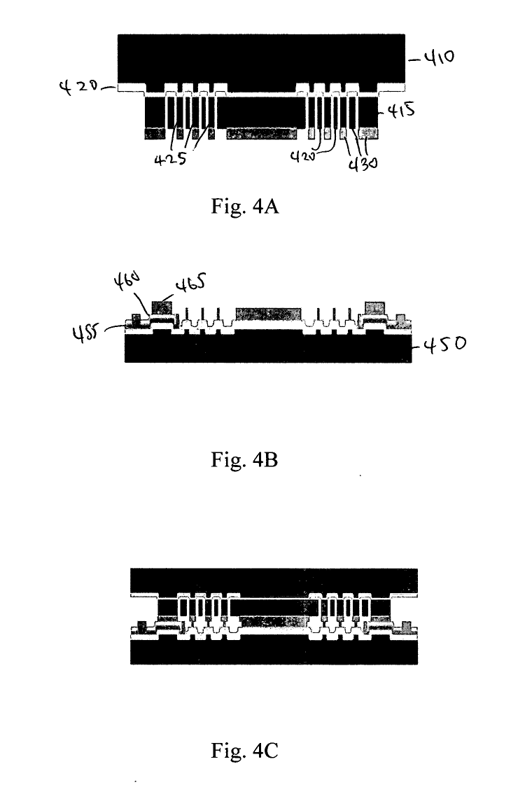

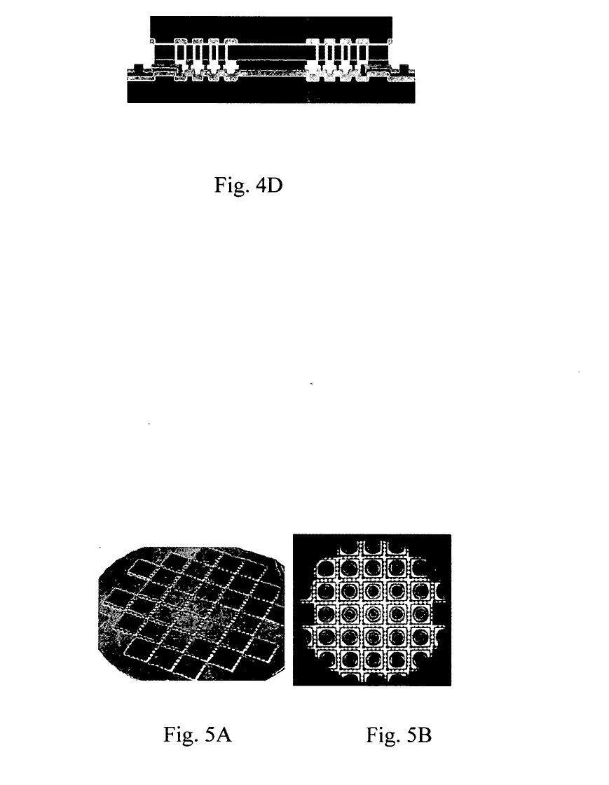

The expected fabrication process includes the following steps, which are illustrated schematically in FIGS. 4A-4D. FIGS. 4A-4D are cross sectional illustrations that are exaggerated in the vertical dimension for clarity.

FIGS. 4A-4D illustrate the fabrication process for a ULE DRG. It is expected that the masks developed for the quartz DRG will be employed for a ULE DRG, and the methodology developed for the conductive coating deposition on the quartz gyro will be utilized on the ULE DRG.

In one phase, it is expected that the resonator and cap will be produced using the steps of:
a. etching pillars on the mechanical end cap 410;
b. fusion bonding a wafer 415 to the end cap;
c. using a photoresist to control the deposition of a metal mask;
d. etching using a DRIE etch to define the resonator 420 and electrode structures 425; and
e. depositing a conductive coating 430 on the etched structures.

The structure so obtained is presented in cross section in FIG. 4A.

The steps of the next three phases are the same processing steps as used in fabricating a Si DRG with the exception that ULE wafers are employed instead of silicon.

In another phase, it is expected that the electrical baseplate will be produced using the steps of:
a. etching pillars on the electrical baseplate 450;
b. performing lithography to define a first metallization 455, depositing the first metallization layer, and defining the metallization by lifting off the excess deposited metal;
c. depositing an oxide layer 460, for example by using a PECVD oxide deposition process; and
d. performing lithography to define a second metallization 465, depositing the second metallization layer, and defining the metallization by lifting off the excess deposited metal.

The structure so obtained is presented in cross section in FIG. 4B.

In another phase, it is expected that the resonator/end cap section and the electrical baseplate will be bonded together. This is expected to be accomplished using a gold-gold compression bond of a conventional type or a silicon-gold eutectic bond. The structure so obtained is presented in cross section in FIG. 4C.

In a final step, it is expected that a wafer comprising a plurality of die, each die being a completed resonant vibratory sensor device, will be diced or sectioned to separate the individual completed a resonant vibratory sensors one from the other. The structure so obtained is presented in cross section in FIG. 4D.

In the fabrication of the Resonator/Cap, it is expected that Deep Reactive Ion Etching (DRIE) will be employed to pattern the ULE glass. The inventor is unaware of any prior published literature on Deep Reactive Ion Etching (DRIE) of ULE glass. Accordingly, it is expected that the DRIE approach of be effective to pattern the ULE glass because ULE glass is similar in chemical composition to other glasses based on SiO₂. Thus, a SiO₂ DRIE system such as the STS AOE (Advanced Oxide Etch) system or the Ulvac NLD (Neutral Loop Discharge) system is expected to be capable of performing the etch. Appropriate etch parameters (gas pressure, platen voltage, etch duration, etc.) will be determined through process development.

In the step of fabrication a suitable DRIE mask for fabricating the Resonator/Cap, it is expected that a conventional photoresist mask will almost certainly be inadequate for the requisite duration of the reactive ion etch. It is expected that the use a metal mask such as Ni will be appropriate. After the etching step, the Ni mask can be removed with an ion milling process. The appropriate thickness of Ni to be deposited as a mask will be determined through process development.

A conductive coating will have to be applied to the resonator to sense the operation of the resonator and to drive the resonator, because ULE glass is non-conductive. In the step of depositing a conductive coating on the Resonator/Cap structure, it is expected that at least one of Atomic Layer Deposition (ALD) and Chemical Vapor Deposition (CVD) will be suitable for depositing the conductive coating. These processes result in very thin conductive coating layers, thus minimizing Q degradation.

The steps of the electrical baseplate fabrication are expected to be identical to those already developed for the Si DRG, aside from the shallow pillar etch of ULE (which can be accomplished by either DRIE or wet etch).

The step of the wafer bond and dicing are expected to be identical to those developed for the Si DRG

FIG. 5A is an illustration of a wafer comprising a plurality of prior art Si DRG devices. FIG. 5B is an illustration showing an IR microscopy image of a silicon DRG that shows the die underneath the silicon cap. A completed ULE DRG wafer is expected to look similar to FIG. 5B due to the optical transparency of ULE glass.

Some of the equipment that is expected to be useful in making the exemplary DRGs includes a GCA Projection Wafer Stepper and an STS Deep Reactive Ion Etcher. The GCA Stepper/Aligner Model 6800 with modified 8000 series Theta II stages is a 5×reduction projection wafer stepper, with a resolution of 0.7 μm (numerical aperture of 0.4), and an alignment accuracy of 0.25 μm. The STS DRIE system utilizes inductively coupled, time multiplexed, plasmas of SF6 and C4F8 gases in order to anisotropically etch silicon. These two plasmas sequentially passivity and etch the silicon until a desired depth is reached. This process, known as the Bosch process, can lead to aspect ratios up to 30:1, profile control up to 90°, with etch rates up to 6 μm/min.

Another useful apparatus is the STS AOE (Advanced Oxide Etcher), which uses fluorine chemistry and a high density inductively coupled plasma to etch deeply (>50 microns) into oxides, glasses and quartz at rates up to 0.5 microns per minute with high selectivity. Typically metal masks are used to resist the ion bombardment. This machine is also capable of anisotropic etching of ceramics.

Packaging of Completed DRGs

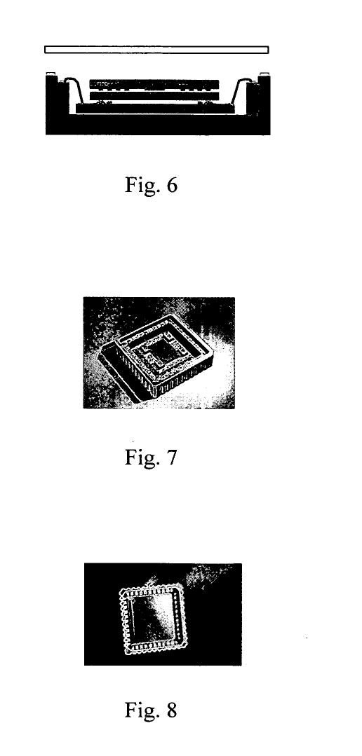

It is expected that DRGs can be packaged using COTS LCC ceramic vacuum packages. The lids for these packages are expected to be provided with evaporable getter material, for example applied by deposition (available from Nanogetters Inc. of 391 Airport Industrial Drive, Ypsilanti, Mich. 48198). It is expected that Au/Sn performs will be attached to the packages. DRG die are expected to be packaged using the ceramic packages, lids with getter material deposited and a carbon chuck, using an elevated temperature vacuum process to seal the assembled packages. Vacuum packaged die are expected to be re-characterized as a check on the packaging process, and to ensure vacuum integrity over time. A cross sectional view of a vacuum package with a DRG die situated therein in shown in FIG. 6. Bond wires are shown for connecting the DRG to electrical access points on the package.

FIG. 7 is a diagram illustrating a concept for a DRG with an ASIC in a LCC package.

The DRG was designed to be compatible with wafer scale vacuum packaging and vacuum packaging using COTS (commercial off-the-shelf) IC packages. Wafer scale vacuum packaging is a process still under development. However, it is known that reliable vacuum packaging in COTS IC packages is viable with current, state-of-the-art industry packaging equipment. The leadless chip carrier (LCC) package shown in FIG. 8 measures 0.65″×0.65″×0.15″. The batch sealing of these types of packages down to 10⁻⁴ torr is possible with the newest vacuum sealing system (model 3150) manufactured by SST International. The 3150 system allows for differential heating of lid and package, while under vacuum, for getter activation.

The steps involved in a prior art COTS vacuum packaging process include:
a Solder bond gyro to COTS package using preform
b. Tack weld Au/Sn preform to package
c. Deposit evaporable getter to Kovar lid
d. In vacuum, heat lid to 400° C. for getter activation; heat package to 280° C.
e. Align lid to getter and bring into contact

In the packaging process, there appear to be no unresolved issues because the 3150 SST vacuum packaging system has shown the ability to reliably and repeatedly achieve vacuums of 10⁻⁴ torr in similar ceramic packages. A package specific carbon chuck must be designed and manufactured to ensure package and lid alignment. Some process development is required to ensure that the requisite temperatures are attained for the specific thermal load put into the chamber.

Electronics

A resonant vibratory sensor requires a power supply and control and sense electronics to operate. Discreet, bipolar analog electronics has been built, tested and demonstrated for operation with the DRG. The discrete, bipolar electronics design developed for the prior art Si DRG can be employed for the ULE DRG. The only modifications required will be the exchange of some passive components within the filter circuits due to the different stiffness (and thus different resonant frequencies) of the ULE glass.

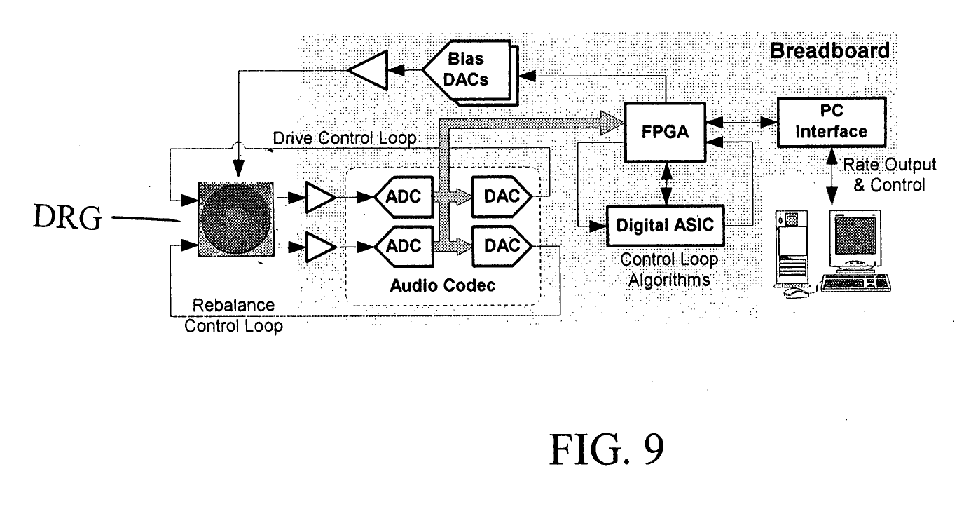

FIG. 9 is a diagram that illustrates an ASCI Breadboard Field Programmable Gate Array (FPGA) based digital electronics module that has been designed for the DRG. An ASIC for the quartz DRG is being developed. A low power ASIC for the DRG is also planned to be prepared. Both digital electronics solutions can be utilized by the ULE DRG.

As illustrated in FIG. 9, the electronics module comprises three control loops, a drive control loop, a rebalance control loop, and an algorithm-based control loop output. In addition, the electronic module comprises rate and quadrature demodulation circuits, and electrostatic tuning biases. This electronics module uses analog interfaces to connect with the vibratory resonator sensor via a plurality of electrodes in symmetric patterns on the electrical baseplate that make a set of capacitors with the conductively coated resonator. The resonator itself is biased at a DC voltage, for example 60 volts.

A set of DC bias electrodes are used to tune the resonator using electrostatic spring softening so that its two degenerate oscillation modes (Mode #1 and Mode #2) become degenerate in frequency. One set of drive electrodes are used to excite oscillation in the Mode #1 direction, and a second set of electrodes is used to sense the oscillation in the Mode #2 direction. In one embodiment, this vibratory motion is kept constant via a positive feedback drive loop which automatically locks onto the natural frequency of the resonator. In some embodiments, automatic gain control (AGC) is used to adjust the gain in this drive loop to maintain a constant amplitude of oscillation. The AGC can be implemented in hardware or in software.

Any inertial rotation of the gyroscope around the Ω axis (or Ω rotation vector, as shown in FIG. 1C) transfers vibratory energy into the second mode (Mode #2), and generates a baseband analog voltage proportional to the inertial rate the gyroscope is undergoing about the Ω axis. Motion in the Mode #2 orientation is sensed via the second set of electrodes that feed into amplifiers, for example transimpedance amplifiers. This motion in the sense (Mode #2) direction is fed directly back in the rebalance control loop with negative feedback, effectively nulling the transferred vibrational energy. The torque needed to null this motion encodes the inertial rate as an amplitude modulated signal in phase with the drive vibration motion (Mode #1). The signals can be processed in either analog or digital processing methods. In the electronics module shown in FIG. 9, the analog signals observed in each of the drive control loop and the rebalance control loop are converted from analog to digital signals using analog-to-digital converters (DACs) and the signals are then processed in the FPGA and digital ASIC. The processed digital signals are used to measure the inertial rate and other operational parameters of interest, and to permit the generation of control signals to be applied to the drive control loop and to the rebalance control loop. The control signals are converted from digital to analog signals in digital-to-analog converters (DACs) and are applied to the respective sets of control pads on the vibratory resonator sensor.

FIG. 9 also illustrates a PC interface and a personal computer including input/output (I/O) of conventional type (such as a keyboard, mouse and display) and machine-readable storage media, such as program and data memory. The personal computer is a conventional general purpose programmable computer. In this embodiment, the personal computer can be used by a user to interact with the electronics module to program the module, to observe the operation of the vibratory resonator sensor (for example during testing) and to interact with the vibratory resonator sensor and the electronics module to observe the behavior of the vibratory resonator sensor and the electronics module in operation. In other embodiments, the PC interface can be replaced with any functionally equivalent interface, including a hardwired interface, an interface connected via radio or other electromagnetic signals not propagated on a wired connection, or via optical signals. In other embodiments, the personal computer can be replaced with any suitable programmable computer, ranging from a handheld microprocessor based device such as a PDA, or a smartphone, through a laptop computer, and including a server, a minicomputer, and a mainframe computer.

In one embodiment, the electronics module comprises loops that are symmetric with respect to the Mode #1 and Mode #2 directions, so that the drive and sense axes can be reversed electronically. This feature of the electronics module allows easy tuning of the device and allows compensation of damping induced rate drift which is cancelable to first order using a drive axis switching technique. In some embodiments, a set of switches can be included so that the drive and sense axes can be reversed via a single digital control line's level shift.

The gyroscope's final rate output signal is generated by the synchronous demodulation of the Mode #1 and Mode #2 signals. An additional demodulation of the sense (Mode #2) signal with a 90° phase shifted copy of the Mode #1 signal can be used to produce a quadrature signal (a measure of improper stiffness coupling between the modes). Feeding this quadrature signal back via a proportional-integral (PI) controller to the tuning bias can be used to automatically null this improper stiffness coupling. In addition, the Mode #1 signal itself can be output to any testing or IMU electronics for other purposes, such as for use in temperature compensation algorithms. As will be recognized, many functions that have traditionally been performed using analog circuitry can also be performed using digital signal processing methods. The present disclosure contemplates the use of digital signal processing methods. The use of conventional prior art power supplies of any form suitable for providing power to the vibratory resonator sensor, to its control circuitry, and to any circuitry needed to interact with the vibratory resonator sensor and its control circuitry is also contemplated.

Testing

A testbed developed for the silicon and quartz DRGs can be used by the ULE gyro. Two pieces of equipment for the testing of gyroscopes are a single and a two axis rate table. Unpackaged gyroscopes are tested in a vacuum chamber mounted atop a single axis rate table. Packaged gyroscopes are tested within the two axis rate table, which can also perform temperature testing.

Theoretical Discussion

Although the theoretical description given herein is thought to be correct, the operation of the devices described and claimed herein does not depend upon the accuracy or validity of the theoretical description. That is, later theoretical developments that may explain the observed results on a basis different from the theory presented herein will not detract from the inventions described herein.

Machine-readable storage media that can be used in the invention include electronic, magnetic and/or optical storage media, such as magnetic floppy disks and hard disks; a DVD drive, a CD drive that in some embodiments can employ DVD disks, any of CD-ROM disks (i.e., read-only optical storage disks), CD-R disks (i.e., write-once, read-many optical storage disks), and CD-RW disks (i.e., rewriteable optical storage disks); and electronic storage media, such as RAM, ROM, EPROM, Compact Flash cards, PCMCIA cards, or alternatively SD or SDIO memory; and the electronic components (e.g., floppy disk drive, DVD drive, CD/CD-R/CD-RW drive, or Compact Flash/PCMCIA/SD adapter) that accommodate and read from and/or write to the storage media. As is known to those of skill in the machine-readable storage media arts, new media and formats for data storage are continually being devised, and any convenient, commercially available storage medium and corresponding read/write device that may become available in the future is likely to be appropriate for use, especially if it provides any of a greater storage capacity, a higher access speed, a smaller size, and a lower cost per bit of stored information. Well known older machine-readable media are also available for use under certain conditions, such as punched paper tape or cards, magnetic recording on tape or wire, optical or magnetic reading of printed characters (e.g., OCR and magnetically encoded symbols) and machine-readable symbols such as one and two dimensional bar codes.

Many functions of electrical and electronic apparatus can be implemented in hardware (for example, hard-wired logic), in software (for example, logic encoded in a program operating on a general purpose processor), and in firmware (for example, logic encoded in a non-volatile memory that is invoked for operation on a processor as required). The present invention contemplates the substitution of one implementation of hardware, firmware and software for another implementation of the equivalent functionality using a different one of hardware, firmware and software. To the extent that an implementation can be represented mathematically by a transfer function, that is, a specified response is generated at an output terminal for a specific excitation applied to an input terminal of a “black box” exhibiting the transfer function, any implementation of the transfer function, including any combination of hardware, firmware and software implementations of portions or segments of the transfer function, is contemplated herein.

While the present invention has been particularly shown and described with reference to the structure and methods disclosed herein and as illustrated in the drawings, it is not confined to the details set forth and this invention is intended to cover any modifications and changes as may come within the scope and spirit of the following claims.

What is claimed is:

1. A resonant vibratory sensor having an output signal proportional to a thermoelastic quality factor, Q_{TE}, wherein Q_{TE} is given by:
$${Q}_{TE} = {Q}_{o} [ \frac{1 + {( ω τ )}^{2}}{2 ( ω τ )} ]$$
$$where$$
$${Q}_{o} = \frac{2 {C}_{v}}{E {α}^{2} {T}_{o}}$$
Cᵥ=specific heat capacity
E=Young's modulus
α=coefficient of thermal expansion
Tₒ=nominal resonator temperature
τ=thermal relaxation time
ω=2π*(frequency of oscillation)
and wherein Qₒ is equal to at least 2,000,000.

2. The resonant vibratory sensor of claim 1, wherein Qₒ is equal to at least 100,000,000.

3. The resonant vibratory sensor of claim 1, wherein the resonant vibratory sensor is formed at least in part from a material having a coefficient of thermal expansion, α, in the range given by −1.0×10⁻⁸≦α≦1.0×10⁻⁸.

4. The resonant vibratory sensor of claim 1, wherein the resonant vibratory sensor is formed at least in part from a material having a coefficient of thermal expansion, α, in the range given by −3.0×10⁻⁸≦α≦3.0×10⁻⁸

5. The resonant vibratory sensor of claim 1, wherein the resonant vibratory sensor is formed at least in part from a glass.

6. The resonant vibratory sensor of claim 1, wherein the resonant vibratory sensor is fabricated using a glass molding process.

7. The resonant vibratory sensor of claim 1, wherein the resonant vibratory sensor is fabricated using a glass machining process.

8. The resonant vibratory sensor of claim 1, wherein the resonant vibratory sensor is formed at least in part from a silicate-based glass.

9. The resonant vibratory sensor of claim 1, wherein the resonant vibratory sensor is formed at least in part from a titania silicate based glass.

10. The resonant vibratory sensor of claim 1, wherein the resonant vibratory sensor is a gyroscope that has an in-run bias stability less than about 0.01 deg/hr.

11. The resonant vibratory sensor of claim 1, wherein the resonant vibratory sensor is a gyroscope that has an in-run bias stability less than about 0.001 deg/hr.

12. The resonant vibratory sensor of claim 1, wherein the resonant vibratory sensor is a gyroscope that has an angle random walk less than about 0.001 deg/hr^{1/2}.

13. The resonant vibratory sensor of claim 1, wherein the resonant vibratory sensor is a MEMS-based resonant vibratory sensor.

14. The resonant vibratory sensor of claim 13, wherein the resonant vibratory sensor has a volume of less than about 10 cm³.

15. The resonant vibratory sensor of claim 13, wherein the resonant vibratory sensor has a volume of about 1 cm³.

16. The resonant vibratory sensor of claim 1, wherein the power required to operate the resonant vibratory sensor is less than about 0.5 watt.

17. The resonant vibratory sensor of claim 1, wherein the power required to operate the device is about 0.15 watt.

18. The resonant vibratory sensor of claim 1, wherein the resonant vibratory sensor is a device selected from the group consisting of an oscillator, a vibratory gyroscope and a vibratory accelerometer.

19. The resonant vibratory sensor of claim 1, wherein the resonant vibratory sensor is a disk resonator gyroscope.

20. The resonant vibratory sensor of claim 1, wherein the resonant vibratory sensor is fabricated in accordance with a dry etching process.

21. The resonant device of claim 20, wherein the dry etching process is a deep reactive ion etching process.

22. A resonant vibratory sensor formed at least in part from a glass material having a coefficient of thermal expansion, α, such that Qₒ is equal to at least 100,000,000 in accordance with the equation:
$${Q}_{TE} = {Q}_{o} [ \frac{1 + {( ω τ )}^{2}}{2 ( ω τ )} ]$$
$$where$$
$${Q}_{o} = \frac{2 {C}_{v}}{E {α}^{2} {T}_{o}}$$
Cᵥ=specific heat capacity
E=Young's modulus
α=coefficient of thermal expansion
Tₒ=nominal resonator temperature
τ=thermal relaxation time
ω=2π*(frequency of oscillation).

23. A resonant vibratory sensor formed at least in part from a glass material in accordance with a dry etching process, wherein the glass material has a coefficient of thermal expansion, α, such that Qₒ is equal to at least 2,000,000 in accordance with the equation:
$${Q}_{TE} = {Q}_{o} [ \frac{1 + {( ω τ )}^{2}}{2 ( ω τ )} ]$$
$$where$$
$${Q}_{o} = \frac{2 {C}_{v}}{E {α}^{2} {T}_{o}}$$
Cᵥ=specific heat capacity
E=Young's modulus
α=coefficient of thermal expansion
Tₒ=nominal resonator temperature
τ=thermal relaxation time
ω=2π*(frequency of oscillation).
